(19) United States
(12) Patent Application Publication
(10) Pub. No.: US 2014/0288922 A1
(43) Pub. Date: Sep. 25, 2014

(54) METHOD AND APPARATUS FOR MAN-MACHINE CONVERSATION

(71) Applicant: TENCENT TECHNOLOGY (SHENZHEN) COMPANY LIMITED, Guangdong (CN)

(72) Inventor: Wen Zha, Guangdong (CN)

(73) Assignee: TENCENT TECHNOLOGY (SHENZHEN) COMPANY LIMITED, Guangdong (CN)

(21) Appl. No.: 14/263,552

(22) Filed: Apr. 28, 2014

Related U.S. Application Data
(63) Continuation of application No. PCT/CN2013/071374, filed on Feb. 5, 2013.

(30) Foreign Application Priority Data
Feb. 24, 2012 (CN) 201210044459.2

(51) Int. Cl. G06F 17/27

(52) U.S. Cl. CPC G06F 17/2785
USPC 704/9

(57) ABSTRACT

The present disclosure is applied to the field of computer technology and provides a method and apparatus for man-machine conversation, including a method for man-machine conversation which is applied to a server, comprising: receiving conversation preceding data transmitted by a first client; acquiring conversation succeeding data matched with the conversation preceding data, the conversation succeeding data including first data collected from at least one second client by forwarding the conversation preceding data to the at least one second client; and returning the conversation succeeding data to the first client. In the present disclosure, for conversation preceding data from a client, the man-machine conversation is completed by collecting data from other client(s) to match corresponding conversation succeeding data and returning the conversation succeeding data to the client transmitting the conversation preceding data. Thereby, a machine's capability of responding to a user's complicated expression and expression fault-tolerance is significantly improved.

### CROSS-REFERENCE TO RELATED APPLICATIONS

This application is a By-pass continuation application of International Application No. PCT/CN2013/071374, filed on Feb. 5, 2013, which claims priority to Chinese patent application No. CN201210044459.2, filed on Feb. 24, 2012, the content of which are incorporated herein by reference in their entirety.

### TECHNICAL FIELD

The present disclosure belongs to the field of computer technology, and particularly relates to a method and apparatus for man-machine conversation.

### BACKGROUND

In the implementation of a man-machine conversation, typically, a client transmits a user's conversation preceding data to a server, and the server recognizes the conversation preceding data semantically, matches it with a corresponding conversation succeeding data, and returns the conversation succeeding data to the client, wherein the corresponding conversation data may be text, voice, picture, video, etc.

### SUMMARY OF THE DISCLOSURE

However, the existing methods for man-machine conversation can only ensure simple man-machine conversations, but do not have processing capabilities for complicated expression and expression fault-tolerance. For example,

(I) A user's expression is “is there a little quieter restaurant” which is a kind of complicated non-quantitative expression, and at this point, a related apparatus cannot perform a corresponding semantic recognition on such a vague qualitative expression of “a little quieter”;

(II) Taking voice data as an example, if “how to defend against a tall center” is recognized as “how to defend against a tall stroke” due to an error during the voice recognition (“center” and “stroke” are pronounced similarly in Chinese), the subsequent semantic recognitions will be wrong accordingly.

In order to address the problem that the existing methods for man-machine conversation can only perform simple man-machine conversations but do not have processing capabilities for complicated expression and expression fault-tolerance, embodiments of the present disclosure provide a method and apparatus for man-machine conversation.

In one aspect of an embodiment of the present disclosure, there is provided a method for man-machine conversation which is applied to a server, comprising: receiving conversation preceding data transmitted by a first client; acquiring conversation succeeding data matched with the conversation preceding data, the conversation succeeding data including first data collected from at least one second client by forwarding the conversation preceding data to the at least one second client; returning the conversation succeeding data to the first client.

In a further aspect of an embodiment of the present disclosure, there is provided a method for man-machine conversation which is applied to a second client, comprising: receiving conversation preceding data from a first client transmitted by a server; receiving conversation succeeding data input by a user according to the conversation preceding data; and transmitting the conversation succeeding data to the server so that the server returns the conversation succeeding data to the first client.

In another aspect of an embodiment of the present disclosure, there is provided an apparatus for man-machine conversation which is located at a server, comprising:

a first conversation preceding data reception unit configured to receive conversation preceding data transmitted by a first client; a conversation succeeding data acquisition unit configured to acquire conversation succeeding data matched with the conversation preceding data, the conversation succeeding data including first data collected from at least one second client by forwarding the conversation preceding data to the at least one second client; and a conversation succeeding data return unit configured to return the conversation succeeding data to the first client.

In a still further aspect of an embodiment of the present disclosure, there is provided an apparatus for man-machine conversation which is located at a second client, comprising: a second conversation preceding data reception unit configured to receive conversation preceding data from a first client transmitted by a server; an input reception unit configured to receive conversation succeeding data input by a user according to the conversation preceding data; and a transmission unit configured to transmit the conversation succeeding data to the server so that the server returns the conversation succeeding data to the first client.

In a still further aspect of an embodiment of the present disclosure, there is provided a computer readable storage medium having stored thereon a computer program containing a program code which, when executed on a computing device, performs respective steps of the method for man-machine conversation.

In the embodiments of the present disclosure, for the conversation preceding data from a client, the man-machine conversation is completed by collecting data from other client(s) to match corresponding conversation succeeding data and returning the conversation succeeding data to the client transmitting the conversation preceding data. Thereby, a machine's capability of responding to a user's complicated expression and expression fault-tolerance is significantly improved.

### BRIEF DESCRIPTION OF THE DRAWINGS

In order to explain technical solutions in embodiments of the present disclosure more clearly, simple introduction of attached drawings needed to be used in the description of embodiments or the prior art will be given below. Apparently, the attached drawings in the description below are only some embodiments of the present disclosure. For those ordinary skilled in the art, other attached drawings can be obtained according to these attached drawings without inventive efforts.

FIG. 1 is a structural block diagram of a system for man-machine conversation provided in a first embodiment of the present disclosure;

FIG. 2 is a flowchart of the implementation at a server of a method for man-machine conversation provided in a second embodiment of the present disclosure;

FIG. 3 is a flowchart of the implementation of a method for man-machine conversation provided in a third embodiment of the present disclosure;

FIG. 4 is a flowchart of the implementation of a method for man-machine conversation provided in a fourth embodiment of the present disclosure;

FIG. 5 is a flowchart of the implementation at a second client of a method for man-machine conversation provided in a fifth embodiment of the present disclosure;

FIG. 6 is a interaction flowchart of a method for man-machine conversation provided in a sixth embodiment of the present disclosure;

FIG. 7 is a structural block diagram of an apparatus for man-machine conversation provided in a seventh embodiment of the present disclosure; and

FIG. 8 is a structural schematic diagram showing an exemplary electronic device which can be used to implement respective embodiments of the present disclosure.

### DETAILED DESCRIPTION

In order to make technical solutions and advantages of the present disclosure more clear, a further detailed description of the present disclosure will be made in conjunction with attached drawings and embodiments below. It should be noted that specific embodiments described here is only used for explaining the present disclosure, but is not used for limiting of the present disclosure.

In the embodiments of the present disclosure, for the conversation preceding data from a client, the man-machine conversation is completed by collecting data from other client(s) to match corresponding conversation succeeding data and returning the conversation succeeding data to the client transmitting the conversation preceding data. Thereby, a machine's capability of responding to a user's complicated expression and expression fault-tolerance is significantly improved.

FIG. 1 shows a structural block diagram of a system for man-machine conversation provided in a first embodiment of the present disclosure. For the convenience of explanation, only parts related to the present embodiment are illustrated.

Referring to FIG. 1, the system for man-machine conversation includes a server 11 and multiple clients, in which a first client 12 receives conversation preceding data input by a user and transmits the same to the server 11. The conversation preceding data include, but are not limited to, data such as voice, text, picture, video, etc., and can be obtained by detecting the input by the user through devices such as a keyboard, mouse, microphone or the like, which is not limited here. After performing semantic recognition on the conversation preceding data, for a part of the conversation preceding data (for example, the conversation preceding data of simple expression), the server 11 directly matches corresponding conversation succeeding data in a preset database and return the conversation succeeding data to the first client 12, while for another part of the conversation preceding data (for example, the conversation preceding data of complicated expression or vague expression), the server 11 collects and matches response data of at least one second client 13 so as to select suitable conversation succeeding data and return the same to the first client 13. Thereby, the data processing capability of the system for man-machine conversation is improved.

In the following, a specific method for man-machine conversation of the system for man-machine conversation is set forth in detail.

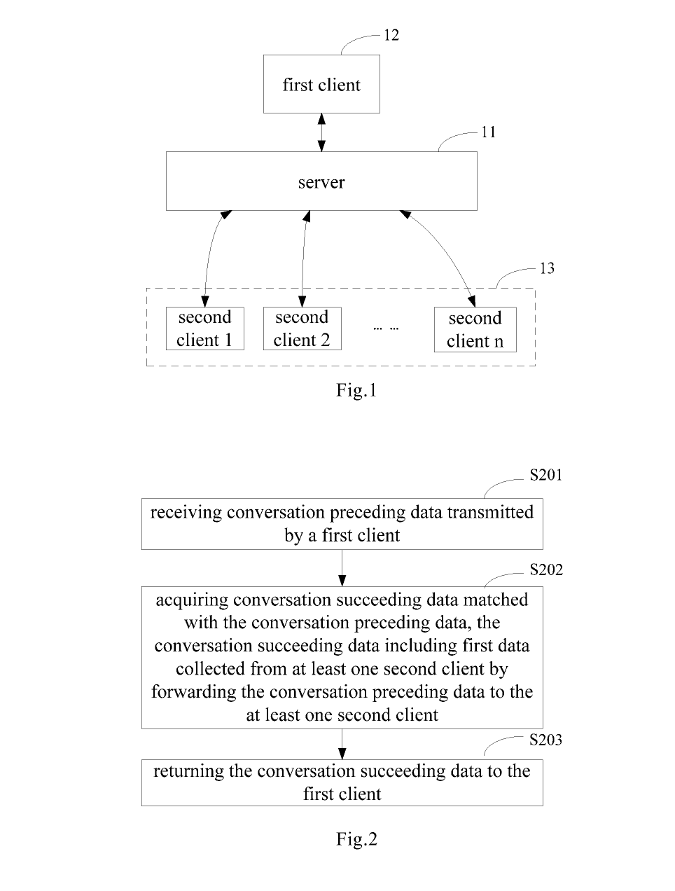

FIG. 2 shows a flowchart of the implementation of a method for man-machine conversation provided in a second embodiment of the present disclosure. In the present embodiment, the subject performing the flow is the client 11 in FIG. 1, and the detailed description is as follows.

In step S201, conversation preceding data transmitted by the first client is received.

In the present embodiment, the conversation preceding data is acquired and transmitted to the server by the first client after the first client collects the information input by a user.

As one embodiment of the present disclosure, after the conversation preceding data transmitted by the first client is received, the type of the conversation preceding data is taken into consideration. When the type of the data is non-text multimedia data such as voice, picture, video, etc., the data needs to be converted after being received, and after the multimedia data is converted into text data, the semantic analysis is further performed. Specific conversion methods may be existing techniques such as voice recognition, image recognition, etc. The conversion method is not the inventive point of the present disclosure and will not be described in detail here for avoiding redundancy.

In step 202, conversation succeeding data matched with the conversation preceding data is acquired, the conversation succeeding data including first data collected from at least one second client by forwarding the conversation preceding data to the at least one second client.

In step 203, the conversation succeeding data is returned to the first client.

In the present embodiment, after acquiring the conversation preceding data from the first client, the server collects and matches corresponding response data from other client(s) (i.e. the second client) and then returns the response data to the first client. In particular, the response data is the response data input by a user of the second client with respect to the conversation preceding data. The collection methods include ways of receiving the first data returned from the second client, receiving and filtering the first data from multiple second clients or the like, which will be described in detail in subsequent embodiments and will not be described in detail here for avoiding redundancy.

At the same time, the returned first data may be text data or multimedia data, such as character, photo, picture, network link, video, etc., which is not limited here.

In the present embodiment, since the returned conversation succeeding data is a user's actual response to the conversation preceding data, when facing complicated expression or vague expression from the conversation preceding data, the returned conversation succeeding data has strong correlation. Meanwhile, since the conversation succeeding data is collected and then returned to the first client by the server, the user of the first client does not feel the existence of the second client and still feels that a man-machine conversation is being performed during an actual conversation. Thereby, the conversation data processing capability of the server is improved on the premise that the user experience is consistent. Meanwhile, the embodiments of the present disclosure do not conduct human response to the conversation data based on an actual call center; thereby the cost of a system is saved.

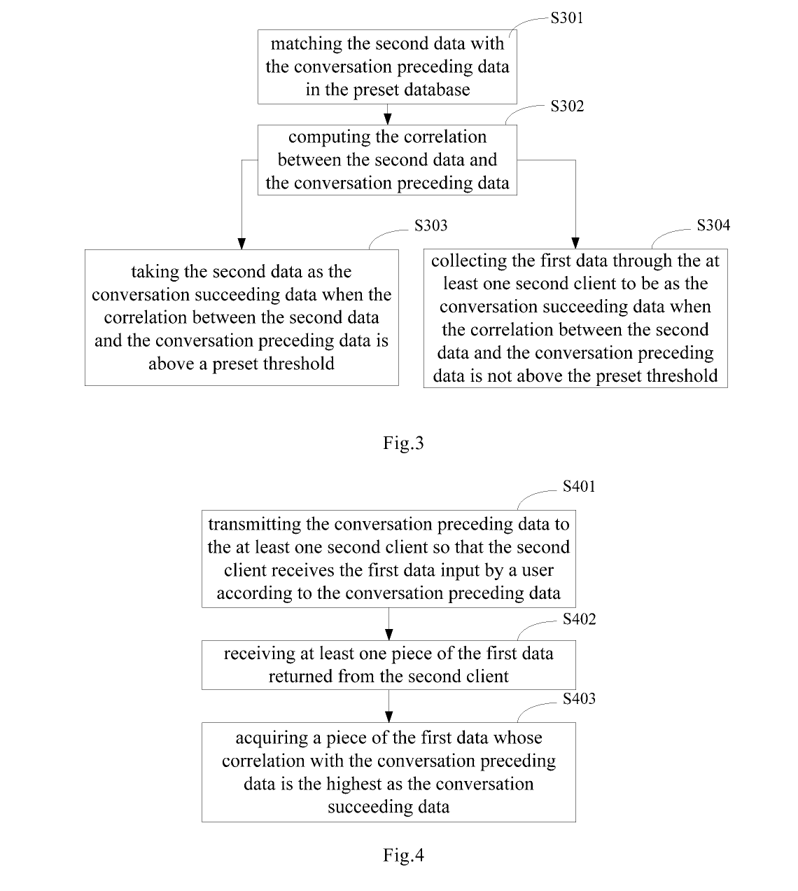

FIG. 3 shows a flowchart of the implementation of a method for man-machine conversation provided in a third embodiment of the present disclosure, in which, according to complicated degree of the conversation preceding data, a simple expression is processed by the server which matches corresponding conversation succeeding data from a preset database, while a complicated expression is processed by the second client. Thereby, the efficiency of man-machine conversation is improved on the premise that matching capability of the response data is ensured. The specific flow is described in detail as follows.

In step S301, second data is matched with the conversation preceding data in the preset database.

In the present embodiment, by performing the semantic analysis on the conversation preceding data, a preset method matches the second data with the conversation preceding data according to the obtained semantics. The preset method includes, but is not limited to, the followings.

1. Artificially Preset Pairing

For example, the conversation preceding data contain a keyword “thanks”, and the returned second data is the preset response data of “you are welcome”.

2. Extracting Keywords in the Conversation Preceding Data According to Word Segmentation, and Searching the Data Containing Such Keywords as the Second Data

3. Comparing the Average Depths of Different Conversation Succeeding Data in the Subsequent Conversation With Each Other

Specific matching method is not the key point of the present disclosure, and is explained by way of example only and not limited here.

In the present embodiment, the corresponding data source in the database can be history data pre-stored in the database and replied by real users.

In step S302, the correlation between the second data and the conversation preceding data is computed.

Specific correlation computation methods can be obtained by performing word segmentation on the second data and the conversation preceding data and then summing or averaging preset correlations between words. Specific correlation computation methods are the prior art and will not be described in detail here for avoiding redundancy.

In step S303, when the correlation between the second data and the conversation preceding data is above a preset threshold, the second data is taken as the conversation succeeding data.

In step S304, when the correlation between the second data and the conversation preceding data is not above the preset threshold, the first data is collected through the second client to be as the conversation succeeding data.

In the present embodiment, by presetting a threshold of correlation, when the correlation between the second data and the conversation preceding data is above the preset threshold, it means that the server understands the semantics of the conversation preceding data well and the returned conversation succeeding data can achieve good user satisfaction; while when the correlation between the second data and the conversation preceding data is not above the preset threshold, it means that the server may fail to understand the semantics of the conversation preceding data well due to the conversation preceding data being complicated in semantics or having wrong expression, and accordingly, it is possible that conversation succeeding data matched from the database by the server is not the conversation succeeding data that the user desires to acquire, resulting in that good user satisfaction cannot be achieved.

In the present embodiment, when the correlation between the second data and the conversation preceding data is not above the preset threshold, the first data whose correlation with the conversation preceding data is high is collected from the second client as the conversation succeeding data to be returned to the first client, so that the user can acquire matched conversation data from the first client. Thereby, the conversation data processing capability of the server is further improved.

FIG. 4 shows a flowchart of the implementation of a method for man-machine conversation provided in a fourth embodiment of the present disclosure, which is the detailed description of collecting the first data through the second client to be as the conversation succeeding data in step S304.

In step S401, the conversation preceding data is transmitted to at least one second client so that the second client receives the first data input by a user according to the conversation preceding data.

In step S402, at least one piece of the first data returned from the second client is received.

In step S403, the piece of the first data whose correlation with the conversation preceding data is the highest is acquired as the conversation succeeding data.

Some preferable implementations of collecting the first data through the second client to be as the conversation succeeding data are set forth in the following by several embodiments.

In a first preferable embodiment, after the server transmits the conversation preceding data to the second client, a user of the second client replies to the conversation preceding data and returns the corresponding first data, and then the server returns the first data as the conversation succeeding data to the first client.

The conversation succeeding data returned by employing this method is the data answered instantly by other user(s) and is of real time to some extent while with stronger matching.

In a second preferable embodiment, after the server transmits the conversation preceding data to the second client, a user of the second client replies to the conversation preceding data and returns the corresponding first data several times piece by piece, and then the server combines the received first data and returns the combined first data as the conversation succeeding data to the first client.

The conversation succeeding data returned by employing this method combines response data input multiple times by the user. Compared with the first preferable embodiment, the conversation succeeding data returned in the present preferable embodiment have stronger integrity and accuracy.

In a third preferable embodiment, the server transmits the conversation preceding data to multiple second clients, users of the multiple second clients reply to the conversation preceding data and then return the corresponding first data respectively, and then, according to the correlation between each of the first data and the conversation preceding data, the server returns one or more pieces of the first data whose correlation is highest or higher (best matched or better matched) as the conversation succeeding data to the first client.

The conversation succeeding data returned by employing this method is not limited to the response data returned by a single user. Meanwhile, the server computes the correlations between multiple pieces of conversation succeeding data and the conversation preceding data and then returns one or more pieces of the conversation succeeding data whose matching is high. Thereby, the conversation processing matching capability of the server is further improved.

In a fourth preferable embodiment, the server transmits the conversation preceding data to multiple second clients having a same user characteristic as the first client, the users of the multiple second clients reply to the conversation preceding data and then return the corresponding first data respectively, and then, according to the correlation between each of the first data and the conversation preceding data, the server returns one or more pieces of the first data whose correlation is highest or higher (best matched or better matched) as the conversation succeeding data to the first client. The user characteristic can be geographical region, age group or the like, and is not limited here.

Compared with the third preferable embodiment, the users returning the conversation succeeding data are all users having some correlation with the user of the first client in characteristics, and thus the returned conversation succeeding data also have larger correlation. Thereby, the conversation processing matching capability of the server is further improved.

FIG. 5 shows a flowchart of the implementation of a method for man-machine conversation provided in a fifth embodiment of the present disclosure. In the present embodiment, the subject performing the flow is the second client 13 in FIG. 1, and the detailed description is as follows.

In step S501, conversation preceding data from the first client transmitted by the server is received.

In step S502, conversation succeeding data input by a user according the conversation preceding data is received.

In step S503, the conversation succeeding data is transmitted to the server so that the server returns the conversation succeeding data to the first client.

The method for man-machine conversation provided in the present embodiment is the same as the methods for man-machine conversation provided in the second to fourth embodiments in implementation principles, and will not be described in detail here for avoiding redundancy.

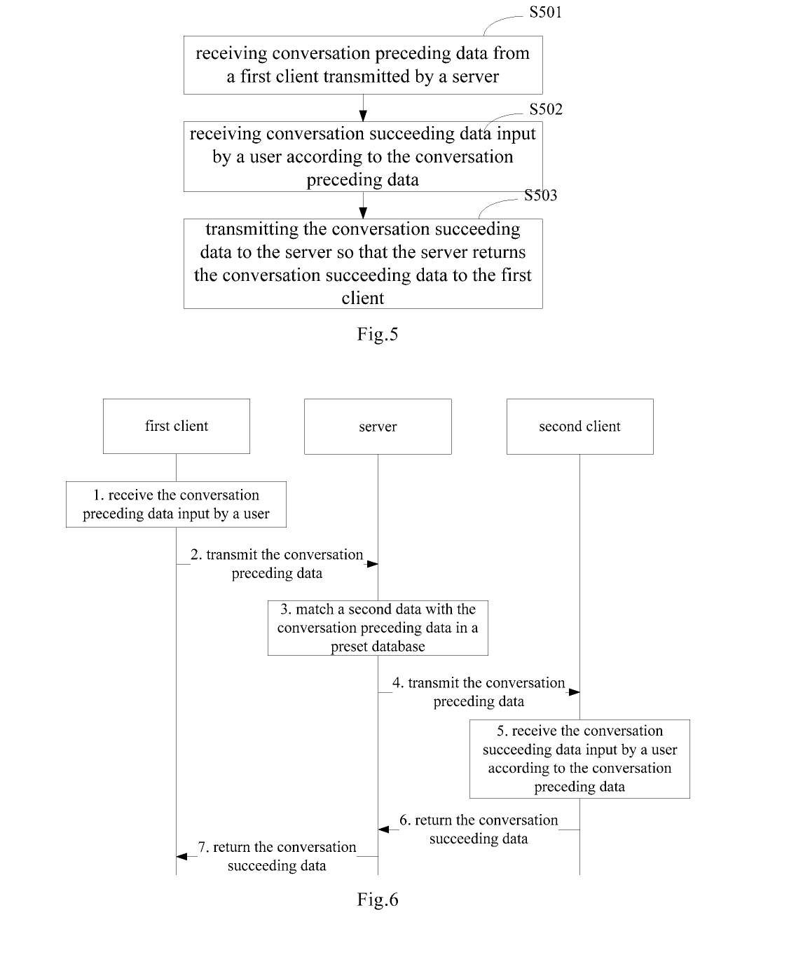

FIG. 6 shows an interaction flowchart of a method for man-machine conversation provided in a sixth embodiment of the present disclosure. The subjects involved in the method include the server 11, the first client 12 and at least one second client 13 as shown in FIG. 1, and the detailed description is as follows.

1. The first client receives the conversation preceding data input by a user.

2. The first client transmits the conversation preceding data to the server.

3. The server matches a second data with the conversation preceding data in a preset database.

4. When the correlation between the second data and the conversation preceding data is not above a preset threshold, the server transmits the conversation preceding data to the second client.

5. The second client receives the conversation succeeding data input by a user according to the conversation preceding data.

6. The second client returns the conversation succeeding data to the server.

7. The server returns the conversation succeeding data to the first client.

In conjunction with the first to fifth embodiments of the present disclosure, the present embodiment sets forth a flowchart of system interaction when the server faces conversation preceding data of complicated expression, and the specific principle thereof may refer to the first to fifth embodiments of the present disclosure and will not be described in detail here for avoiding redundancy.

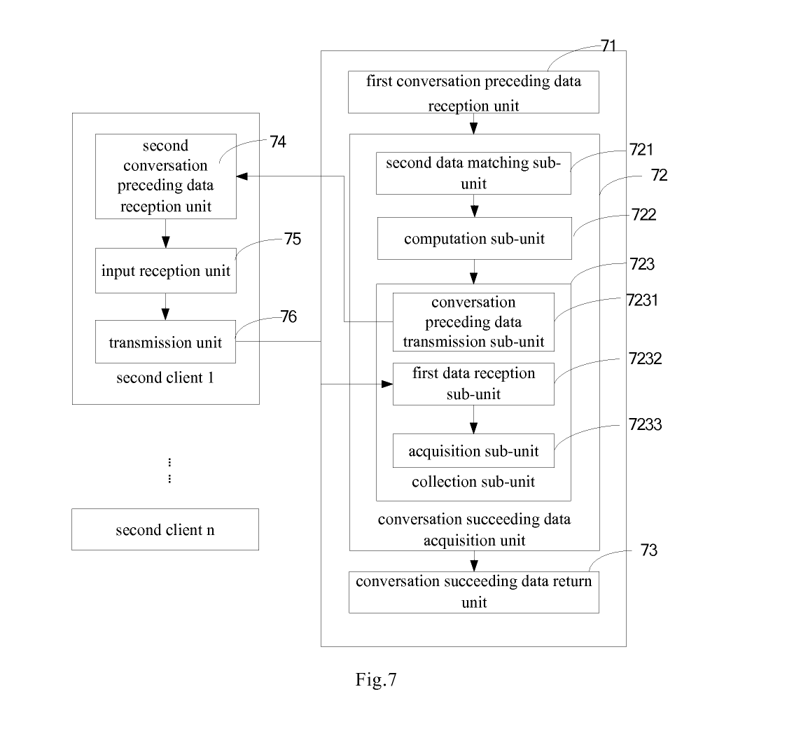

FIG. 7 shows the structure of an apparatus for man-machine conversation provided in a seventh embodiment of the present disclosure. The apparatus is used for implementing the methods for man-machine conversation provided in the first to sixth embodiments of the present disclosure, and may be executed at a server and multiple clients in a system for man-machine conversation respectively. For the convenience of explanation, only parts related to the present embodiment are illustrated.

Referring to FIG. 7, At the server, the apparatus can include: a first conversation preceding data reception unit 71 configured to receive conversation preceding data transmitted by a first client; a conversation succeeding data acquisition unit 72 configured to acquire conversation succeeding data matched with the conversation preceding data, the conversation succeeding data including first data collected from at least one second client; and a conversation succeeding data return unit 73 configured to return the conversation succeeding data to the first client.

The conversation succeeding data can further include a second data acquired from a preset database. Accordingly, the conversation succeeding data acquisition unit 72 can include: a second data matching sub-unit 721 configured to match the second data with the conversation preceding data in the preset database so as to take the second data as the conversation succeeding data when the correlation between the second data and the conversation preceding data is above a preset threshold; a computation sub-unit 722 configured to compute the correlation between the second data and the conversation preceding data; and a collection sub-unit 723 configured to collect the first data through at least one second client to be as the conversation succeeding data when the correlation between the second data and the conversation preceding data is not above the preset threshold.

Further, the collection sub-unit 723 can include: a conversation preceding data transmission sub-unit 7231 configured to transmit the conversation preceding data to at least one second client, so that the second client receives the first data input by the user according to the conversation preceding data; a first data reception sub-unit 7232 configured to receive at least one piece of the first data returned by the second client; and an acquisition sub-unit 7233 configured to acquire a piece of the first data whose correlation with the conversation preceding data is the highest as the conversation succeeding data.

At the second client, the apparatus can include: a second conversation preceding data reception unit 74 configured to receive conversation preceding data from a first client transmitted by a server; an input reception unit 75 configured to receive conversation succeeding data input by a user according to the conversation preceding data; and a transmission unit 76 configured to transmit the conversation succeeding data to the server, so that the server returns the conversation succeeding data to the first client.

In the embodiments of the present disclosure, for the conversation preceding data from a client, the man-machine conversation is completed by collecting data from other client(s) to match corresponding conversation succeeding data and returning the conversation succeeding data to the client transmitting the conversation preceding data. Thereby, a machine's capability of responding to a user's complicated expression and expression fault-tolerance is significantly improved.

It can be understood by those ordinary skilled in the art that all or part of steps for implementing the above embodiments can be implemented by hardware or can be implemented by related hardware instructed by a program which can be stored in a computer readable storage medium which may be a ROM (Read Only Memory)/RAM (Random Access Memory), a magnetic disk, a optical disc or the like. For example, the present disclosure may be implemented as a computer readable storage medium having stored thereon a computer program containing a program code which, when executed on a computing device, performs respective steps of the method for man-machine conversation as describe above.

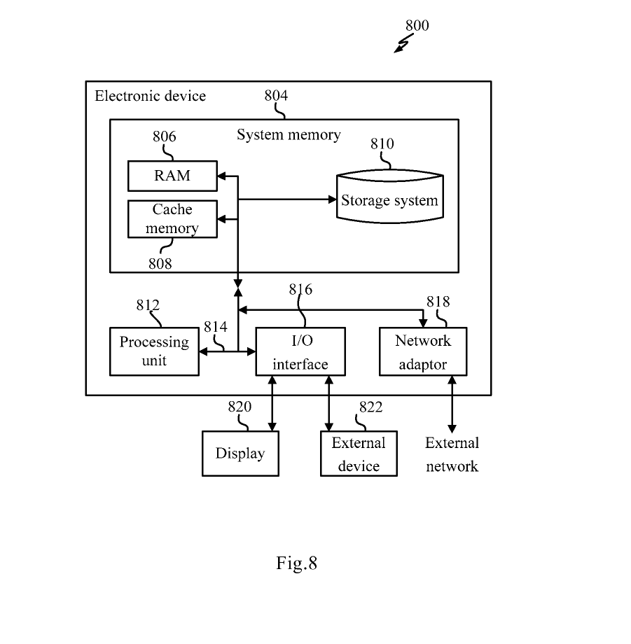

FIG. 8 is a structural schematic diagram showing an exemplary electronic device which can be used to implement respective embodiments of the present disclosure.

The electronic device 800 shown in FIG. 8 is only an example and is not limiting of the functionality and the scope of use of embodiments of the disclosure. As shown in FIG. 8, the electronic device 800 may be in a form of a general purpose computing device. Components of the electronic device 800 may include, but are not limited to, one or more processors or processing units 812, a system memory 804, an I/O interface 816, a network adapter 818, a display 820 and a bus 814 that couples various components, and may be connected to an external device 822.

The bus 814 represents one or more of several types of bus structures. For example, such bus structures include, but are not limited to, Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and so on.

The electronic device 800 typically includes a variety of computer system readable media. Such medium may be any readable media that is accessible by the electronic device 800, and it includes both volatile and non-volatile media, and both removable and non-removable media.

The system memory 804 can include readable media in the form of volatile memory, such as random access memory (RAM) 806 and/or cache memory 808. The electronic device 800 may further include other removable/non-removable, volatile/non-volatile storage media. For example, the storage system 810 (typically called a “hard drive”) can be provided for reading from and writing to a non-removable, non-volatile magnetic media. Although not shown, a magnetic disk drive for reading from and writing to a removable, non-volatile magnetic disk (e.g., a “U disk”), and an optical disk drive for reading from or writing to a removable, non-volatile optical disk such as a CD-ROM, DVD-ROM or other optical media can be provided. In such instances, each drive can be connected to the bus 814 by one or more data medium interfaces.

The system memory 804 may include at least one program product having a set (for example, at least one) of program modules which may be stored in the storage system 810. The program module contains a computer executable program instruction. Such program modules are configured to perform functions of respective embodiments of the present disclosure by the processing units 812 executing the program instruction therein. Such program modules include, but are not limited to, an operating system, one or more application programs, other program modules, and program data. Each of these examples of program modules or some combination thereof may include an implementation of a networking environment.

The electronic device 800 may also communicate with one or more external devices 822 such as a keyboard, a mouse, the display 820, etc.; and one or more devices that enable a user to interact with the electronic device 800. Such communication can occur via the Input/Output (I/O) interface 816. Further, the electronic device 800 can also communicate with one or more networks such as a local area network (LAN), a general wide area network (WAN), and/or a public network (e.g., the Internet) via the network adapter 818 such as a network card, modem, etc. As shown in FIG. 8, the I/O interface 816 and the network adapter 818 communicates with the other modules of the electronic device 800 via the bus 814. It should be understood that although not shown, other hardware and/or software modules can be used in conjunction with the electronic device 800. Such other hardware and/or software modules include, but are not limited to: microcode, device drivers, redundant processing units, external disk drive arrays, RAID systems, tape drives, and data archival storage systems, etc.

Respective units or steps in respective embodiments of the present disclosure may all be implemented by executing program modules having computer program instructions in the electronic device 800.

The described above is only preferable embodiments of the present disclosure and is not intended to limit the present disclosure. Any modification, equivalent replacement, improvement, etc made within the spirit and principle of the present disclosure should fall within the protection scope of the present disclosure.

What is claimed is:

1. A method for man-machine conversation which is applied to a server, comprising:
receiving conversation preceding data transmitted by a first client;
acquiring conversation succeeding data matched with the conversation preceding data, the conversation succeeding data including first data collected from at least one second client by forwarding the conversation preceding data to the at least one second client;
returning the conversation succeeding data to the first client.

2. The method according to claim 1, wherein the conversation succeeding data further comprises second data acquired from a preset database, and
the step of acquiring the conversation succeeding data matched with the conversation preceding data comprises:
matching the second data with the conversation preceding data in the preset database;
computing correlation between the second data and the conversation preceding data;
taking the second data as the conversation succeeding data when the correlation between the second data and the conversation preceding data is above a preset threshold; and
collecting the first data through the at least one second client to be as the conversation succeeding data when the correlation between the second data and the conversation preceding data is not above the preset threshold.

3. The method according to claim 2, wherein the step of collecting the first data through the at least one second client to be as the conversation succeeding data comprises:
transmitting the conversation preceding data to the at least one second client so that the second client receives the first data input by a user according to the conversation preceding data;
receiving at least one piece of the first data returned from the second client; and
acquiring one piece of the first data whose correlation with the conversation preceding data is the highest as the conversation succeeding data.

4. The method according to claim 2, wherein the step of collecting the first data through the at least one second client to be as the conversation succeeding data comprises:
transmitting the conversation preceding data to the at least one second client so that the second client receives the first data input by a user according to the conversation preceding data;
receiving the first data returned from the second client; and
taking the first data as the conversation succeeding data.

5. The method according to claim 2, wherein the step of collecting the first data through the at least one second client to be as the conversation succeeding data comprises:
transmitting the conversation preceding data to the at least one second client so that the second client receives the first data input by a user according to the conversation preceding data;
receiving a plurality of pieces of the first data returned several times from the second client; and
combining the plurality of pieces of the first data received several times as the conversation succeeding data.

6. The method according to claim 1 wherein the second client is a client having a same user characteristic as the first client, the user characteristic comprising the geographical region and the age of the users of the clients.

7. A method for man-machine conversation which is applied to a second client, comprising:
receiving conversation preceding data from a first client transmitted by a server;
receiving conversation succeeding data input by a user according to the conversation preceding data; and
transmitting the conversation succeeding data to the server so that the server returns the conversation succeeding data to the first client.

8. The method according to claim 7, wherein the step of transmitting the conversation succeeding data to the server so that the server returns the conversation succeeding data to the first client comprises:
transmitting the conversation succeeding data to the server several times so that the server combines the conversation succeeding data and returns the same to the first client.

9. An apparatus for man-machine conversation which is located at a server, comprising:
a first conversation preceding data reception unit configured to receive conversation preceding data transmitted by a first client;
a conversation succeeding data acquisition unit configured to acquire conversation succeeding data matched with the conversation preceding data, the conversation succeeding data including first data collected from at least one second client by forwarding the conversation preceding data to the at least one second client; and
a conversation succeeding data return unit configured to return the conversation succeeding data to the first client.

10. The apparatus according to claim 9, wherein the conversation succeeding data further comprises second data acquired from a preset database, and
said conversation succeeding data acquisition unit comprises:
a second data matching sub-unit configured to match the second data with the conversation preceding data in the preset database so as to take the second data as the conversation succeeding data when correlation between the second data and the conversation preceding data is above a preset threshold;
a computation sub-unit configured to compute the correlation between the second data and the conversation preceding data; and
a collection sub-unit configured to collect the first data through the at least one second client to be as the conversation succeeding data when the correlation between the second data and the conversation preceding data is not above the preset threshold.

11. The apparatus according to claim 10, wherein the collection sub-unit comprises:
a conversation preceding data transmission sub-unit configured to transmit the conversation preceding data to the at least one second client so that the second client receives the first data input by a user according to the conversation preceding data;
a first data reception sub-unit configured to receive at least one piece of the first data returned by the second client;
an acquisition sub-unit configured to acquire a piece of the first data whose correlation with the conversation preceding data is the highest as the conversation succeeding data.
